(19) United States
(12) Patent Application Publication
(10) Pub. No.: US 2005/0153577 A1
(43) Pub. Date: Jul. 14, 2005

(54) Electronic system for expandably connecting backplanes of hard disks

(75) Inventor: Cheng-Yin Shen, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 10/996,824

(22) Filed: Nov. 24, 2004

(30) Foreign Application Priority Data
Jan. 9, 2004 (TW) 93100516

(51) Int. Cl. H01R 12/00

(52) U.S. Cl. 439/61

(57) ABSTRACT

An electronic system for expandably connecting backplanes of hard disks to a motherboard in a RAID includes a plurality of backplanes, and a motherboard having a connector thereon connecting to a first one of the backplanes. Each backplane includes: a first connector mounted on a front edge thereof, the first connector having N ports; and a second connector mounted at a rear edge thereof, the second connector having N ports. Each port of the first connector is electrically connected to each port of the second connector in a predetermined staggered sequence. The backplanes are connected consecutively, such that a previous backplane communicates via the N ports of the second connector thereof with the N ports of the first connector of a next backplane. A same port on the input or the output connector of each of the backplanes is fixed as a data input of each of the backplanes.

### BACKGROUND OF THE INVENTION

1. Field of the Invention

The present invention pertains to electronic equipment such as computers, and more particularly to a system for expandably connecting backplanes of hard disks.

2. Prior Art of the Invention

A Redundant Array of Independent Disks (RAID) is a solution for storing data in more than one physical hard disk. The RAID employs the technique of stripping for partitioning the storage space of each physical hard disk into small units. Therefore, a signal record is divided into several segments stored in different physical hard disks, and can be accessed quickly by reading the hard disks at the same time.

Generally, the above-mentioned physical hard disks are respectively contained in disk boxes, and a backplane of each disk box is connected to a motherboard of a controller via a data cable. In this way, the motherboard can communicate with the physical hard disks by receiving data from and transmitting data to the backplanes via the data cables.

FIG. 2 shows the architecture of a commonly used system 200 for connecting a plurality of backplanes 220, 230, 240, 250 to a motherboard 210. The backplanes 220, 230, 240, 250 are respectively connected to ports 211, 212, 213, 214 of the motherboard 210 in one-to-one correspondence. That is, the port 211 of the motherboard 210 receives data from the backplane 220 via a data cable 260, the port 212 of the motherboard 210 receives data from the backplane 230 via a data cable 270, the port 213 of the motherboard 210 receives data from the backplane 240 via a data cable 280, and the port 214 of the motherboard 210 receives data from the backplane 250 via a data cable 290.

Because distances from each backplane 220, 230, 240, 250 to the motherboard 210 are not the same, different lengths of the data cables 260, 270, 280, 290 are required in order to provide the above-mentioned connections. In addition, in order to install new backplanes in the system 200 correctly, data cables having different lengths to those of the data cables 260, 270, 280, 290 must be provided.

FIG. 3 shows the architecture of another commonly used system 300 for connecting backplanes 320, 330, 340, 350 to a motherboard 310. The backplanes 320, 330, 340, 350 are connected to ports 311, 312, 313, 314 of the motherboard 310 in series via a plurality of data cables 360, 370, 380, 390. The data cables 370, 380, 390 between each two consecutive of the backplanes 320, 330, 340, 350 are of the same standard. Each of backplanes 320, 330, 340, 350 employs a jumper for transferring data from an input connector to an output connector thereof. The jumper is usually a short length of wire used in a circuit for temporarily completing a circuit or bypassing a break. Thus, when a new backplane is added to the system 300, a jumper must be employed for transmitting data in the new backplane.

In summary, each of the systems 200, 300 has its particular shortcomings, which can lead to unduly high costs at the time of initial installation and also at time of expansion and maintenance. Thus, an electronic system that overcomes the aforementioned shortcomings is desired.

### SUMMARY OF THE INVENTION

Accordingly, an object of the present invention is to provide an efficient electronic system for expandably connecting backplanes of hard disks in a RAID.

In order to accomplish the above-mentioned object, an electronic system for expandably connecting backplanes of hard disks in a RAID comprises a motherboard and plural backplanes. The motherboard has a connector mounted thereon, which receives data from and transmits data to the backplanes. The connector of the motherboard has N ports that are connected to N ports of the first backplane in one-to-one correspondence. Each of the backplanes has a similar structure, which comprises an input connector mounted on the front edge thereof and an output connector mounted on the rear edge thereof. The backplanes are connected consecutively, such that a previous backplane communicates via N ports of an output connector thereof with N ports of an input connector of a next baclplane. N is a natural number greater than 2.

That is, each of the input connector and the output connector of each backplane comprises N ports, which are named as a first port, a second port, a third port, and so on through to, or including, an Nth port. The N ports of the input connector are directly connected to the N ports of the output connector, for transmitting data from the input connector to the output connector. There are no jumpers. Each port of the input connector is electrically connected to each port of the output connector in a predetermined sequence. That is, the first port of the output connector is connected to the Nth port of the input connector, the second port of the output connector is connected to the first port of the input connector, the third port of the output connector is connected to the second port of the input connector, and so on through to, or including, the Nth port of the output connector is connected to the (N−1)th port of the input connector. A same port on the input or the output connector of each of the backplanes is fixed as a data input port of each of the backplanes.

The motherboard is connected to the first backplane via a primary data cable. The communication between the output connector of the previous backplane and the input connector of the next backplane is via a secondary data cable.

Other objects, advantages and novel features of the present invention will be drawn from the following detailed description of exemplary embodiments of the present invention with the attached drawings, in which:

### BRIEF DESCRIPTION OF THE DRAWINGS

FIG. 1 is a schematic diagram of architecture of an electronic system for expandably connecting backplanes in accordance with an exemplary embodiment of the present invention;

FIG. 2 is a schematic diagram of architecture of a conventional electronic system for expandably connecting backplanes; and

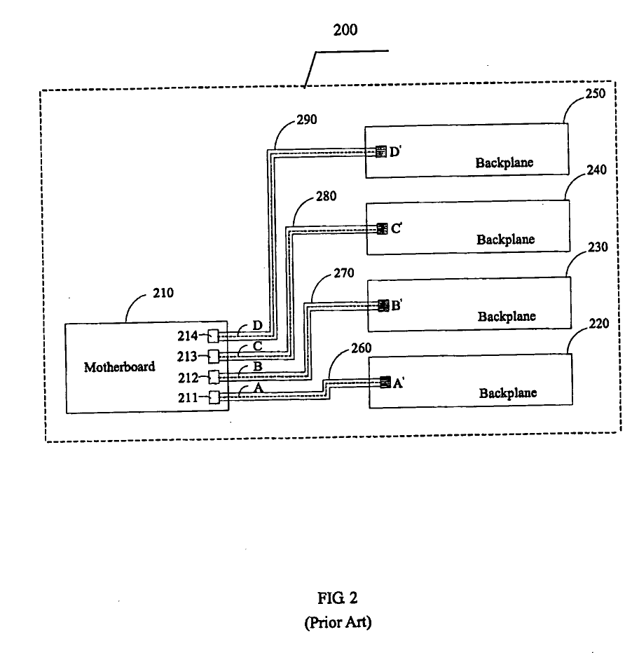

FIG. 3 is a schematic diagram of architecture of another conventional electronic system for expandably connecting backplanes.

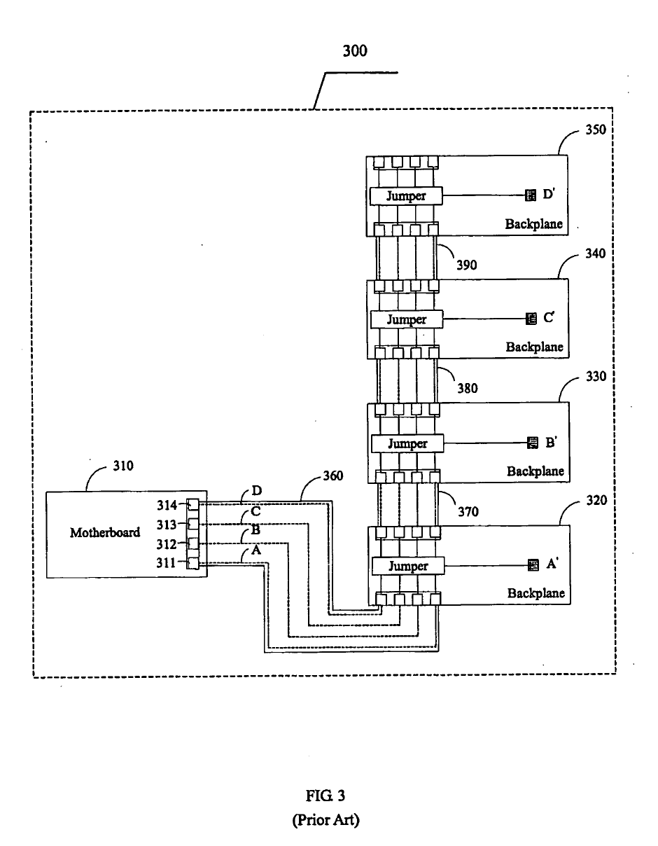

### DETAILED DESCRIPTION OF EMBODIMENTS OF THE INVENTION

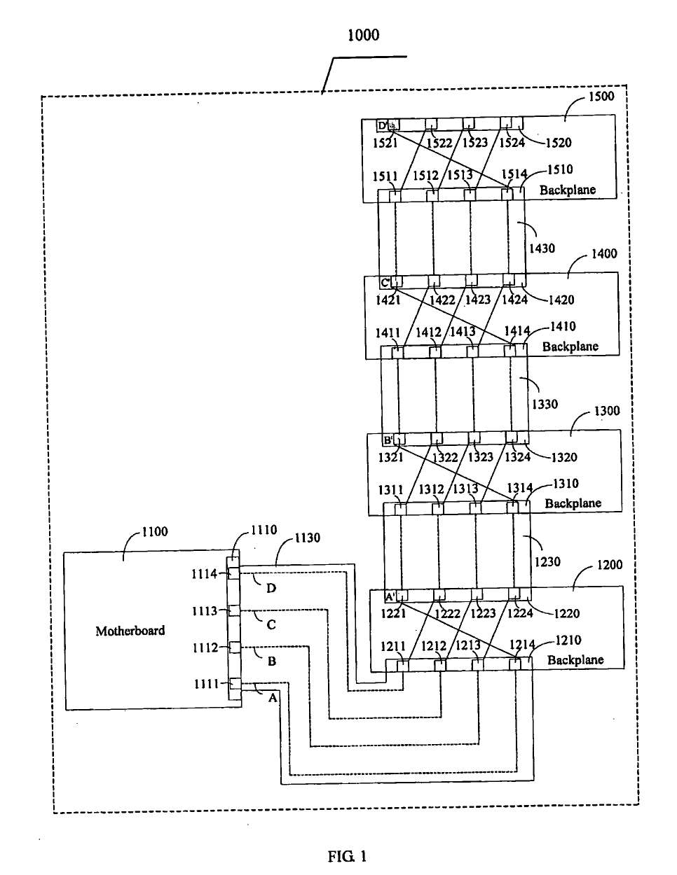

FIG. 1 is a schematic diagram of an electronic system 1000 for expandably connecting backplanes in accordance with an exemplary embodiment of the present invention. The system 1000 comprises a motherboard 1100 as a control subsystem, four backplanes 1200, 1300, 1400, 1500 as functional subsystems, a primary data cable 1130, and three secondary data cables 1230, 1330, 1430. Having only the four backplanes 1200, 1300, 1400, 1500 makes the system 1000 relatively simple and easy to understand. The backplane 1200 is connected to the motherboard 1100 via the primary data cable 1130 in a combined data transmission way. In turn, the backplanes 1300, 1400, 1500 are connected in series via the secondary data cables 1230, 1330, 1430, respectively. That is, the backplane 1300 is connected to the backplane 1200 via the secondary data cable 1230, the backplane 1400 is connected to the backplane 1300 via the secondary data cable 1330, and the backplane 1500 is connected to the backplane 1400 via the secondary data cable 1430.

The motherboard 1100 comprises a third connector 1110, which comprises four ports 1111, 1112, 1113, 1114. The ports 1111, 1112, 1113, 1114 are provided for receiving data from and transmitting data to the backplane 1200 via the primary data cable 1130.

The backplane 1200 comprises an input connector 1210 and an output connector 1220. The input connector 1210 is mounted on a front edge of the backplane 1200, and is used for receiving data from and transmitting data to the motherboard 1100. The input connector 1210 comprises four ports 1211, 1212, 1213, 1214. The output connector 1220 is mounted on a rear edge of the backplane 1200, and is used for receiving data from and transmitting data to the backplane 1300. The output connector 1220 comprises four ports 1221, 1222, 1223, 1224. The ports 1211, 1212, 1213, 1214 of the input connector 1210 are respectively connected to the ports 1222, 1223, 1224, 1221 of the output connector 1220 in one-to-one correspondence. Among the ports 1211, 1212, 1213, 1214, the port 1221 of the output connector 1220 is fixed as a data input port of the backplane 1200 in the embodiment of the invention.

The port 1111 of the third connector 1110 is electrically connected to the port 1214 of the input connector 1210, the port 1112 of the third connector 1110 is electrically connected to the port 1213 of the input connector 1210, the port 1113 of the third connector 1110 is electrically connected to the port 1212 of the input connector 1210, and the port 1114 of the third connector 1110 is electrically connected to the port 1211 of the input connector 1210.

The backplanes 1300, 1400, 1500 have similar structures to that of the backplane 1200. A port 1321 of an output connector 1320 is fixed as a data input port of the backplane 1300, a port 1421 of an output connector 1420 is fixed as a data input port of the backplane 1400, and a port 1521 of an output connector 1520 is fixed as a data input port of the backplane 1500.

In order to transmit data from the motherboard 1100 to the backplanes 1300, 1400, 1500, the secondary data cables 1230, 1330, 1430 are provided for connecting the backplanes 1200, 1300, 1400, 1500 in series. The secondary data cable 1230 connects the output connector 1220 of the backplane 1200 to an input connector 1310 of the backplane 1300. The ports 1221, 1222, 1223, 1224 of the output connector 1220 are electrically connected to the ports 1311, 1312, 1313, 1314 of the input connector 1310 in one-to-one correspondence. The ports 1321, 1322, 1323, 1324 of the output connector 1320 are electrically connected to ports 1411, 1412, 1413, 1414 of an input connector 1410 of the backplane 1400 in one-to-one correspondence. The ports 1421, 1422, 1423, 1424 of the output connector 1420 are electrically connected to ports 1511, 1512, 1513, 1514 of an input connector 1510 of the backplane 1500 in one-to-one correspondence.

At the beginning of operation of the electronic system 1000, data A, B, C, D are generated by the motherboard 1100, and the data A, B, C, D are separately output by the ports 1111, 1112, 1113, 1114. The data A, B, C, D are transmitted to the ports 1211, 1212, 1213, 1214 of the input connector 1210 via the primary data cable 1130. The electrical connections between the input connector 1210 and the output connector 1220 are configured in order to change the relative sequence of output ports of the transmitted data A, B, C, D. That is, the ports 1221, 1222, 1223, 1224 of the output connector 1220 respectively receive the data A, D, C, B. In particular, the data input port 1221 of the backplane 1200 receives the data A transmitted from the motherboard 1100. The other data B, C, D are transmitted to the backplanes 1300, 1400, 1500 according to a mechanism similar to that described above. In this way, the data input ports 1321, 1421, 1521 respectively receive the data B, C, D.

In other embodiments of the present invention, the number of backplanes may be less than or more than four, according to the practical requirements of users. The number of data ports of the motherboard 1100 is equal to or greater than the number of backplane. A same port on the input or the output connector of each of the backplanes is fixed as the data input port of each of the backplanes.

Although only an exemplary embodiment of the present invention has been described in detail above, those skilled in the art will readily appreciate that many modifications to the exemplary embodiment are possible without materially departing from the novel teachings and advantages of the present invention. Accordingly, all such modifications are deemed to be covered by the following claims and allowable equivalents of the claims.

1. An electronic system comprising:
a plurality of backplanes, each of the backplanes comprising:
a first connector mounted at a front edge of the backplane, the first connector having N ports that can be named as a first port, a second port, a third port, and so on through to, or including, an Nth port;
a second connector mounted at a rear edge of the backplane, the second connector having N ports, wherein a first port of the second connector is connected to the Nth port of the first connector, a second port of the second connector is connected to the first port of the first connector, a third port of the second connector is connected to the second port of the first connector, . . . , and the Nth port of the second connector being connected to the (N−1)th port of the first connector;
wherein the backplanes are connected consecutively, in such that a previous backplane communicates via the N ports of the second connector thereof with the N ports of the first connector of a next backplane; and
a motherboard comprising a connector having N ports, the N ports of the connector of the motherboard being connected to the N ports of the first connector of a first one of the backplanes in one-to-one correspondence;
wherein N is a natural number equal to or greater than 3.

2. The electronic system as recited in claim 1, wherein the motherboard is connected to the first backplane via a primary data cable.

3. The electronic system as recited in claim 1, wherein the communication between the second connector of the previous backplane and the first connector of the next backplane is via a secondary data cable.

4. The electronic system as recited in claim 1, wherein the number of data ports of the motherboard is equal to or greater than the number of the backplanes.

5. The electronic system as recited in claim 1, wherein a same port on the first or the second connector of each of the backplanes is fixed as a data input port of each of the backplanes.

6. An electronic system comprising:
a control subsystem; and
a plurality of functional subsystems connected to said control subsystem in a serial connection by cables having a predetermined sequence of data transmission therein between said control subsystem and each of said plurality of functional subsystems; wherein
said predetermined sequence of said data transmission in each of said cables is altered by a prior one of said plurality of functional subsystems in said serial connection before said data transmission continues to a next one of said plurality of functional subsystems in said serial connection.

7. The electronic system as recited in claim 6, wherein a first data of said predetermined sequence of said data transmission is moved as the last one thereof by said prior one of said plurality of functional subsystems in said each of said cables.

8. A method to arrange data transmission in an electronic system, comprising the steps of:
providing a control subsystem;
electrically connecting a plurality of functional subsystems to said control subsystem in a serial connection of a predetermined sequence;
transmitting data between said control subsystem and each of said plurality of functional subsystems in a combined way of said predetermined sequence;
altering said predetermined sequence of said combined format after said data is transmitted to a prior one of said plurality of functional subsystems in said serial connection and before said data transmission continues to a next one of said plurality of functional subsystems in said serial connection; and
repeating said transmitting and altering steps until said data is transmitted to all of said plurality of functional subsystems in said serial connection.

9. The method as recited in claim 8, wherein a first data of said data of said predetermined sequence is moved as the last one thereof in said altering step.
